(19) United States
(12) Patent Application Publication
(10) Pub. No.: US 2009/0122656 A1
(43) Pub. Date: May 14, 2009

(54) CROWN FOR TIMEPIECE

(75) Inventors: Pierre-Jean Bonnet, Courtelary (CH); Georges Zimmermann, Kuttigkofen (CH)

Correspondence Address: GRIFFIN & SZIPL, PC, SUITE PH-1, 2300 NINTH STREET, SOUTH, ARLINGTON, VA, 22204, US

(73) Assignee: Meco S.A., Grenchen (CH)

(21) Appl. No.: 12/249,054

(22) Filed: Oct. 10, 2008

(30) Foreign Application Priority Data
Nov. 8, 2007 (EP) 07120281.6

(51) Int. Cl. G04B 37/00

(52) U.S. Cl. 368/308

(57) ABSTRACT

Crown for a timepiece, said crown (1) including a cap (2) extended by a skirt (4) which delimits a hollow inner housing (6), said crown (1) being characterized in that an at least partially transparent cover (14) is mounted in the cap (2), said cover (14) revealing all or part of a device (18) arranged in the hollow inner housing (6) of the crown (1).

This application claims priority from European Patent Application No. 07120281.6 filed Nov. 8, 2007, the entire disclosure of which is incorporated herein by reference.

### FIELD OF THE INVENTION

The present invention concerns a crown, for example for the winding stem or push-button of a timepiece. More specifically, the present invention concerns a crown of this type providing an innovative and attractive aesthetic effect.

### BACKGROUND OF THE INVENTION

A crown of the aforementioned type is known for example from EP Patent Application No. 1 586 960 in the name of the Applicant. This concerns a timepiece crown including an uncoupling device. The crown includes a hollow cylindrical housing inside which are arranged a pipe onto which a winding stem is secured and an element capable of deforming elastically and cooperating, in rotation, with a rigid notched ring type element. This cooperation in rotation is ensured provided that the torque transmitted by the notched ring to the elastically deformable element remains below a predetermined threshold. When this threshold is passed, a phenomenon of uncoupling is observed between the notched ring and the elastic element. In other words, there is no longer any transmission of the rotational torque between the notched ring and the elastic element. The crown then rotates without any transmission action, and its rotational movement is thus not transmitted to the winding stem.

The structure of the crown briefly described above is that of a disconnectable crown. The purpose of such a crown is to avoid damaging the timepiece mechanism particularly if the user attempts to wind the mechanism of his watch when the mainspring is completely wound.

In one of the embodiments of the crown described in the aforementioned European Patent Application, the elastically deformable element is formed by a spring including a central base whose shape is generally close to that of a square and from four elastically deformable arms extend. Each of the elastic arms includes two successive portions namely a first short portion extending from the central base along a substantially radial direction before exhibiting an elbow substantially at right angles, and a second substantially rectilinear portion in the extension of the first portion, after the bent portion.

Of course, the geometry of the flat spring element described above obeys, above all, physical and mechanical principles which determine the efficiency of the transmission of torque between the notched ring and said spring element and the threshold beyond which uncoupling is observed between these two elements. Nonetheless, it should be noted that, because of its geometry and symmetrical nature, the spring element is not without certain attractiveness.

It is this attractiveness that the author of the invention, which forms the subject of this Patent Application, wishes to reveal to the watch user.

### SUMMARY OF THE INVENTION

The present invention therefore concerns a crown for a timepiece, said crown including a cap extended by a skirt that delimits a housing, said crown being characterized in that an at least partially transparent cover is mounted in the cap, said cover revealing all or part of a device arranged in the crown housing.

Owing to these features, the present invention provides a crown, for example for a timepiece winding stem or push button, which makes the device housed inside the inner volume of the crown visible to the user. This device may be, for example, an uncoupling mechanism as described above. It could however simply be a decorative plate carrying, for example, the distinctive sign of the timepiece brand or any other ornamental decoration. In the case of the uncoupling mechanism, the user will be able to see all the details and fine features of the parts and even observe the working of the mechanism. The present invention therefore provides a new type of crown with an attractive and innovative appearance.

### BRIEF DESCRIPTION OF THE DRAWINGS

Other features and advantages of the present invention will appear more clearly from the following detailed description of an embodiment of the crown according to the invention, this example being given purely by way of non limiting illustration with reference to the annexed drawing, in which:

FIG. 1 is a longitudinal cross-section of a timepiece crown according to the invention;

FIG. 2 is a top view of the crown shown in FIG. 1, and

FIG. 3 is a perspective view of the crown according to the invention.

### DETAILED DESCRIPTION OF THE PREFERRED EMBODIMENTS

The present invention proceeds from the general inventive idea that consists in making a device housed in the inner volume of a crown visible to the user, for example for a timepiece winding stem or push button. The device housed in the crown may be an uncoupling mechanism for a winding stem with a flat spring type elastic element and a notched ring on the inner periphery thereof. It may also be a plate carrying the distinctive trademark of the timepiece brand or any other decorative design. To achieve this result, an at least partially transparent cover is mounted in the head of the crown, leaving all or part of the device housed in the inner volume of the crown visible. Owing to this construction, the timepiece fitted with one or several crowns and/or push buttons according to the invention has an attractive and innovative appearance.

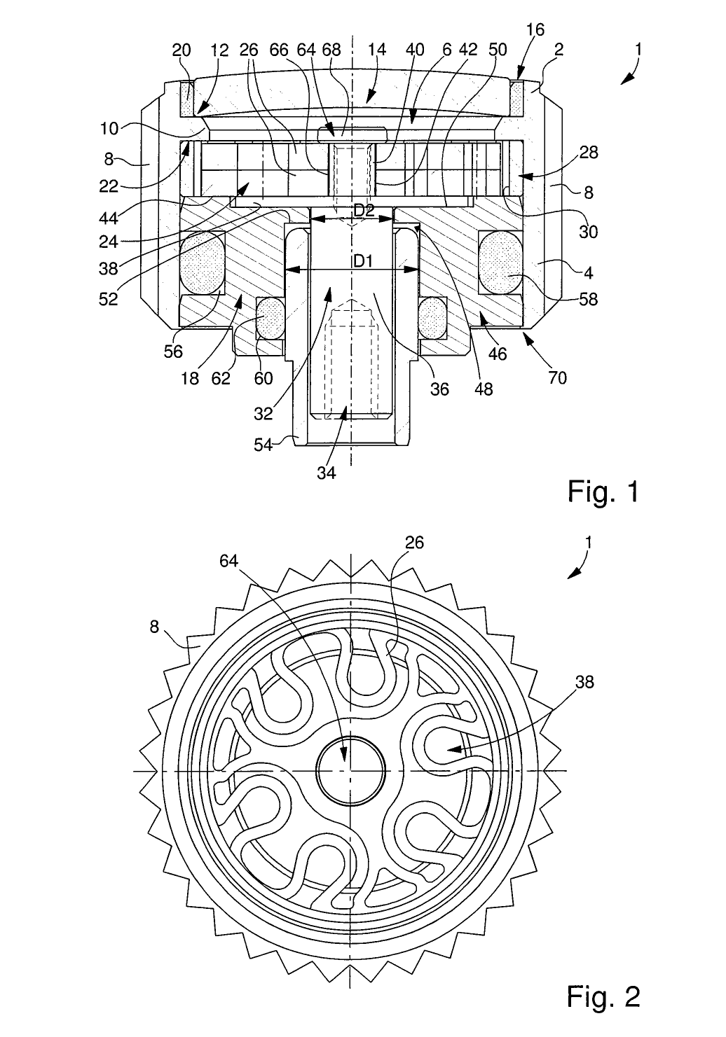

FIG. 1 shows a longitudinal cross-section of a crown in accordance with the teaching of the present invention, designated as a whole by the general reference numeral 1. As shown in FIG. 1, crown 1 has a generally cylindrical shape. It goes without saying, however, that crown 1 may differ from shapes with an ellipsoid revolution shaped section, to take any other general external shape with a square, octagonal or other polyhedral section.

Crown 1 is essentially formed of a cap 2 delimited towards the bottom by a circular skirt 4, which delimits a hollow inner housing 6. In the example shown in the drawing, cap 2 and circular skirt 4 are made in a single piece. Of course, one could also envisage making these two parts separately and then assembling them by any appropriate means.

The external periphery of skirt 4 has a plurality of flutes 8 for facilitating handling of crown 1 for the user. The hollow inner housing 6 of crown 1 has a circular shoulder 10. This shoulder 10 has two functions. On the one hand, it delimits a support surface 2 for a cover 14 housed in an aperture 16 made in cap 2 of crown 1. In accordance with the invention, this cover 14 is at least partially transparent in order to reveal a device 18 housed in the hollow inner volume 6 of crown 1. In the example shown in the drawing, cover 14 is formed by a glass plate or transparent plate mounted in aperture 16 with the insertion of a sealing gasket 20.

The other function of shoulder 10 is to act as a stop surface 22 for device 18 housed in the hollow inner volume 6 of crown 1. As shown in FIG. 1 shows and better still in FIG. 2, this device 18 is, in this case, formed by an uncoupling mechanism 24 whose purpose is to protect the movement of the timepiece by preventing the user from winding the mainspring beyond a predetermined limit value.

Uncoupling mechanism 24 therefore includes one, and preferably two identical superposed springs 26. Two identical springs 26 are provided here in order to attain the thickness necessary to obtain the desired level of rigidity.

The two springs 26 cooperate with a ring 28 in a way that will be described below. The external diameter of ring 28 is equal to the inner diameter of circular skirt 4. The inner periphery of ring 28 has a plurality of notches 30.

As can be seen upon examining FIG. 2, notched ring 28 and the two springs 26 are arranged in the bottom of crown 1, abutting against stop surface 22 embodied by circular shoulder 10. A pipe 32 that has a threaded hole 34 for mounting a winding stem (not shown) completes uncoupling mechanism 24. Pipe 32 has a main part 36 of cylindrical section on which a disc-shaped head 38 is mounted, the diameter of said head being greater than the diameter of main part 36. A projecting portion 40, whose contour is inscribed inside the perimeter of head 38 of pipe 32, is mounted on head 38. More specifically, the perimeter of projecting portion 40 is for example square shaped and is inscribed in a hole 42, which is also square, made in springs 26, such that, when a rotational movement is imparted to said springs 26, the latter then drive pipe 32 in turn, via projecting portion 40. Of course, the shape of projecting portion 40 and that of holes 42 may differ from that of a square and have any non-circular profile, such as for example a polygon, without departing from the scope of the present invention, provided that it remains possible for said springs 26 to drive said projecting portion 40.

As FIG. 1 shows, springs 26 abut on head 38 of pipe 32 and partly on a circular edge 44 of a generally cylindrical shaped bush 46. More specifically, bush 46 has a through hole 48, which opens into a bore 50 of the same shape and dimensions as head 38 of pipe 32, and which delimits circular edge 44 on which springs 26 abut.

Moreover, through hole 48 has a local reduction in diameter 52, where its diameter passes from a value D1 greater than the external diameter of a tube 54 to a value D2 less than D1 and greater than the external diameter of main part 36 of pipe 32. It will also be noted that bush 46 has an external peripheral groove 56 which houses a sealing gasket 58 and an internal peripheral groove 60 which houses a sealing gasket 62. The function of gasket 58 is to guarantee the seal between bush 46 and hollow inner housing 6 of crown 1, whereas gasket 62 guarantees the seal between said bush 46 and tube 54.

The crown according to the invention is mounted in the following manner. First of all, pipe 32 is engaged in bush 46 until head 38 of said pipe 32 is housed in bore 50 of said bush 46. Springs 26 are then engaged on projecting portion 40 of pipe 32, the a screw 64 is screwed into a threaded hole 66 made in head 38 of pipe 32 and which may extend as far as into main part 36 of pipe 32. It will be noted that springs 26 are maintained between head 38 of pipe 32 and head 68 of screw 64. Notched ring 28 is arranged in the hollow inner housing 6 of crown 1 by any appropriate means such as driving in, welding or other means in order to obtain a rigid connection between these two parts. The assembly formed by pipe 32, bush 46, springs 26 and screw 64 is then engaged in the hollow inner housing 6 of crown 1. Bush 46 is secured to crown 1 by any appropriate means such as driving in, welding, bonding or riveting as indicated at 70. Crystal 14 and gasket 20 can then be mounted on crown 1.

When assembly of the crown is finished, the winding stem is screwed into threaded hole 34 made in pipe 32. Finally, the whole assembly is mounted in the timepiece via a tube 54, which is secured by any appropriate technique such as driving in, screwing or bonding onto the middle part of the timepiece. This tube 54 connects crown 1 according to the invention to the timepiece mechanism that said crown 1 has to activate.

Crown 1 according to the invention operates as follows. When the user rotates crown 1, he drives notched ring 28, which itself drives springs 26. Ring 28 may drive springs 26 in a single direction or two directions, clockwise or anticlockwise. To finish, springs 26 drive pipe 32 and thus the threaded stem (not shown) secured thereto in rotation. When the torque exerted by crown 1 on springs 26 exceeds a predetermined threshold, springs 26 are elastically deformed such that notched ring 28 is uncoupled and is no longer meshed on said springs 26. Crown 1 thus rotates without any torque transmission action such that subsequent activation thereof no longer has any effect on the timepiece movement and in particular on the main spring, which avoids any risk of damaging the movement.

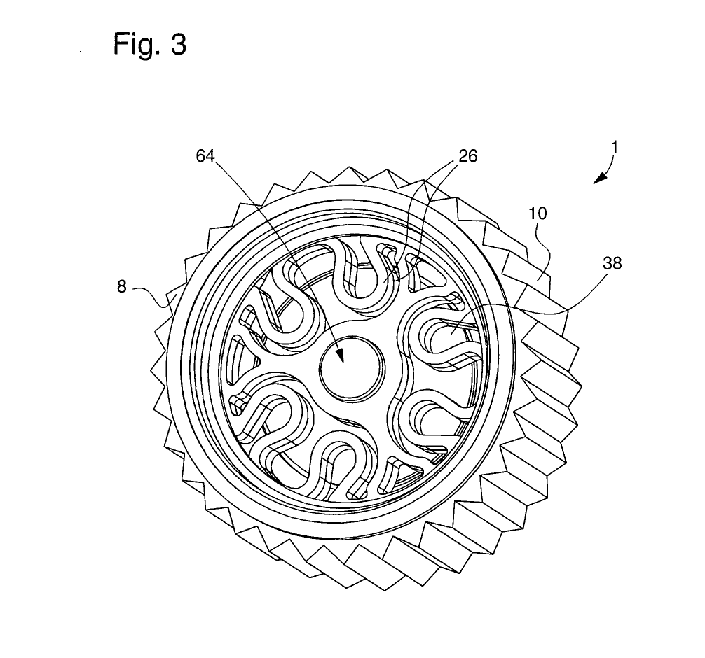

As will be appreciated in FIGS. 2 and 3, springs 26 and screw 64 are visible to the user through crystal 14, which gives the timepiece an innovative and attractive appearance.

It goes without saying that the present invention is not limited to the embodiment that has just been described and that various simple alterations and variants could be envisaged by those skilled in the art without departing from the scope of the invention as defined by the annexed claims. In particular, it will be understood that the crown according to the invention can be applied to any type of external timepiece control members such as correctors, push buttons, valves or others.

What is claimed is:

1. A crown for a timepiece, said crown including a cap extended by a skirt, which delimits a hollow inner housing, wherein an at least partially transparent cover is mounted in the cap, said cover revealing all or part of a device arranged in the hollow inner housing of the crown.

2. The crown according to claim 1, wherein the cover is mounted in an aperture made in the cap of the crown.

3. The crown according to claim 1, wherein the cover is a transparent plate mounted with the insertion of a sealing gasket in the aperture.

4. The crown according to claim 1, wherein the device is formed by an uncoupling mechanism.

5. The crown according to claim 2, wherein the device is formed by an uncoupling mechanism.

6. The crown according to claim 3, wherein the device is formed by an uncoupling mechanism.

7. The crown according to claim 4, wherein the uncoupling mechanism includes at least one spring cooperating with a ring that has a plurality of notches on the inner periphery thereof.

8. The crown according to claim 5, wherein the uncoupling mechanism includes at least one spring cooperating with a ring that has a plurality of notches on the inner periphery thereof.

9. The crown according to claim 6, wherein the uncoupling mechanism includes at least one spring cooperating with a ring that has a plurality of notches on the inner periphery thereof.

10. The crown according to claim 7, wherein the spring or springs are maintained by means of a screw.

11. The crown according to claim 8, wherein the spring or springs are maintained by means of a screw.

12. The crown according to claim 9, wherein the spring or springs are maintained by means of a screw.

13. The crown according to claim 10, wherein there is a hole of non-circular shape at the centre of the spring or springs via which said springs are engaged onto a projecting portion of complementary shape of a pipe which carries said springs, said screw being screwed into a threaded hole made at least in the projecting portion of the pipe.

14. The crown according to claim 11, wherein there is a hole of non-circular shape at the centre of the spring or springs via which said springs are engaged onto a projecting portion of complementary shape of a pipe which carries said springs, said screw being screwed into a threaded hole made at least in the projecting portion of the pipe.

15. The crown according to claim 12, wherein there is a hole of non-circular shape at the centre of the spring or springs via which said springs are engaged onto a projecting portion of complementary shape of a pipe which carries said springs, said screw being screwed into a threaded hole made at least in the projecting portion of the pipe

16. The crown according to claim 1, wherein it is applied to an external control member of the timepiece.

17. The crown according to claim 16, wherein the control member is a winding stem or a push-button.
